(19) United States
(12) Patent Application Publication
(10) Pub. No.: US 2012/0197428 A1
(43) Pub. Date: Aug. 2, 2012

(54) Method For Making a Piñata

(76) Inventor: Scott Weaver, Tampa, FL (US)

(21) Appl. No.: 13/015,967

(22) Filed: Jan. 28, 2011

(51) Int. Cl. G06F 17/00; G06K 15/02

(52) U.S. Cl. 700/117; 358/1.2

(57) ABSTRACT

A method of making a piñata having a realistic image on the piñata itself. The steps include (1) providing a three-dimensional geometric object having a hollow center; (2) providing a two-dimensional image; (3) creating a digital copy of the two-dimensional image on an electronic device; (4) manipulating the digital image of the two-dimensional image into a digital image wherein the digital image can be placed around the three-dimensional geometric object; (5) preparing the digital image onto a material; (6) affixing the hard copy of the digital image to said three-dimensional geometric object; and (7) filling the geometric object with a plurality of objects.

### CROSS-REFERENCES TO RELATED APPLICATIONS

Not Applicable

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of piñatas. More specifically, the invention comprises a method of making a piñata with a realistic image affixed to it.

2. Description of the Related Art

Piñatas are a popular novelty item for all kinds of events and occasions. Piñatas are made of a hard shell filled with candy, toys or other goodies inside. Typically, children are given a stick or bat to try to break the piñata. Upon breaking the piñata the candies or goodies are released from inside of the piñata for the children to collect them.

Currently the outer shell of piñatas are made from materials such as cardboard, newspaper, paper and/or a paste made of flour, water and other adhesive product like glue, regular past and polyurethanes. The hard shell is typically formed into the shape of an animal or colorful design, by utilizing different colored papers. A prior art method of making a piñata is shown in FIGS. 1 and 2, comprising the steps of: (1) Providing a support structure 14, such as a balloon; (2) Providing and coating strips 16 of newspaper or paper in a paste 18; (3) Layering strips 16 on the support structure 14; (4) Drying strips 16 completely until a hardened geometric object 24 is formed; (5) Removing support structure 14, for example popping the balloon; (6) Providing a securing hook 20 and attaching a hanging line 22, preferably, a rope, wire or string; and (7) Decorating geometric object 24 with colorful strips 26, often made up of tissue paper.

The animal or colorful designs are often unrealistic in appearance due to the nature of the colored paper strips. However, it is desirable to have a more realistic design on a piñata. This would allow the piñata to take on the appearance of a particular individual, animal or even place.

Therefore what is needed is a method of creating a piñata with a detailed picture, portrait or drawing. The present invention achieves this objective, as well as others that are explained in the following description.

### BRIEF SUMMARY OF THE INVENTION

The present invention is a method of making a piñata having a realistic image on the piñata itself. The steps of the method include (1) providing a three-dimensional geometric object having a hollow center; (2) providing a two-dimensional image; (3) creating a digital copy of the two-dimensional image on an electronic device; (4) manipulating the digital image of the two-dimensional image into a digital image wherein the digital image can be placed around the three-dimensional geometric object; (5) preparing the digital image onto a material; (6) affixing the hard copy of the digital image to said three-dimensional geometric object; and (7) filling the geometric object with a plurality of objects.

The two-dimensional image may need to be manipulated such that the image can be wrapped around the geometric object while still appearing life-like. The purpose is to provide a truly realistic or clean image for use on a piñata.

### BRIEF DESCRIPTION OF THE SEVERAL VIEWS OF THE DRAWINGS

FIG. 1 is a perspective view, showing a prior art method of making a piñata.

FIG. 2 is a perspective view, showing a prior art piñata.

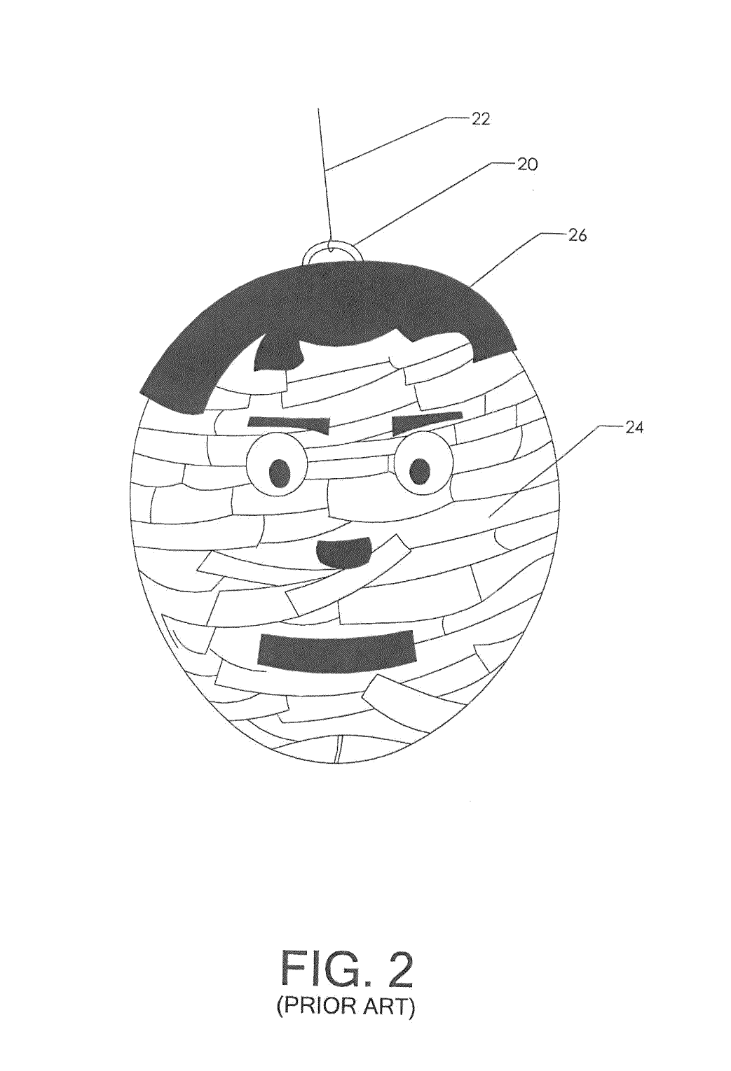

FIG. 3 is a schematic view, showing the preferred steps of the present method of making a piñata.

FIG. 4 is a perspective view, showing a three-dimensional geometric object.

FIG. 5 is a perspective view, showing a two-dimensional image.

FIG. 6 is a perspective view, showing a computer and digital image on the computer.

FIG. 7 is a perspective view, showing a computer wherein the digital image is modified.

FIG. 8 is a perspective view, showing a computer attached to a printer, wherein the printer is printing a hard copy of the digital image.

FIG. 9 is a perspective view, showing the hard copy being affixed to the three-dimensional object.

FIG. 10 is a perspective view, showing a piñata made using the present method.

FIG. 11 is a schematic view, showing an alternate embodiment of the present method.

FIG. 12 is a perspective view, showing a silk-screen printing device, wherein a hard copy of the digital image is being formed.

FIG. 13 is a schematic view, showing an alternate embodiment of the present method.

REFERENCE NUMERALS IN THE DRAWINGS

| | | | |
|---|---|---|---|
| 10 | geometric object | 12 | opening |
| 14 | support structure | 16 | strips |
| 18 | paste | 20 | hook |
| 22 | line | 24 | geometric object |
| 26 | colorful strips | 28 | two-dimensional image |
| 30 | computer | 32 | crop box |
| 34 | digital image | 36 | hard copy |
| 38 | printer | 40 | adhesive |
| 42 | objects | 44 | piñata |
| 48 | silk-screen device | 50 | body |

### DETAILED DESCRIPTION OF THE INVENTION

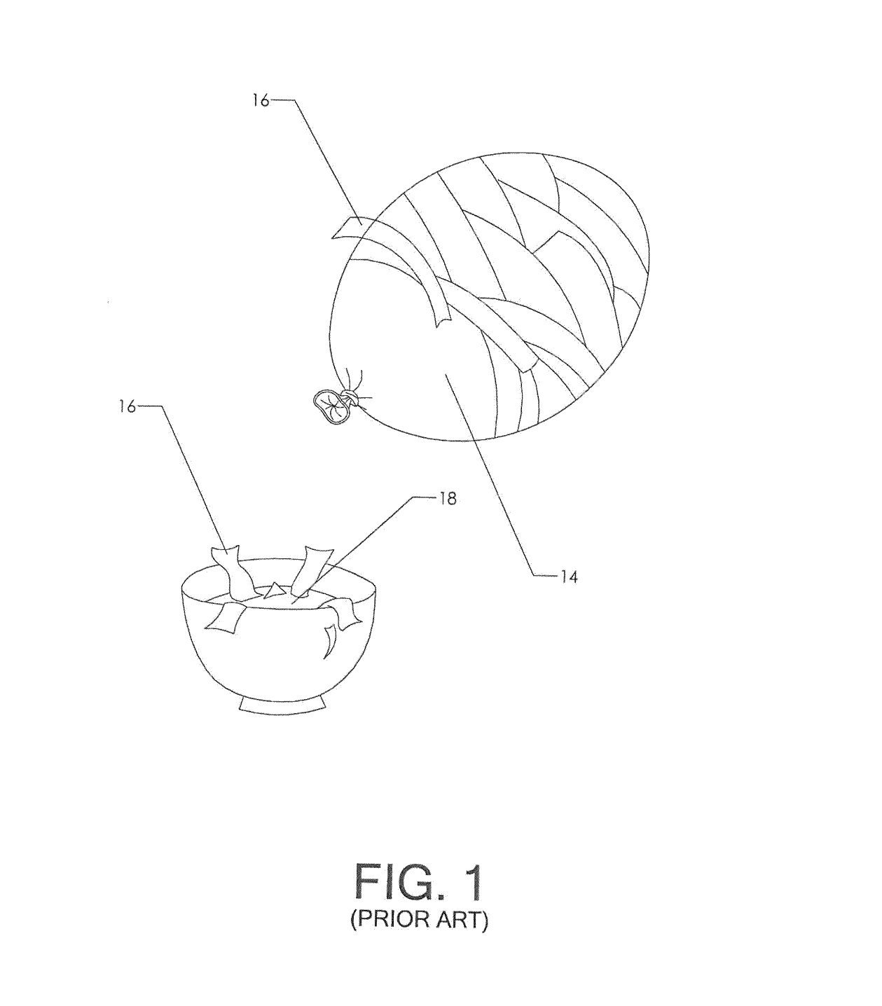

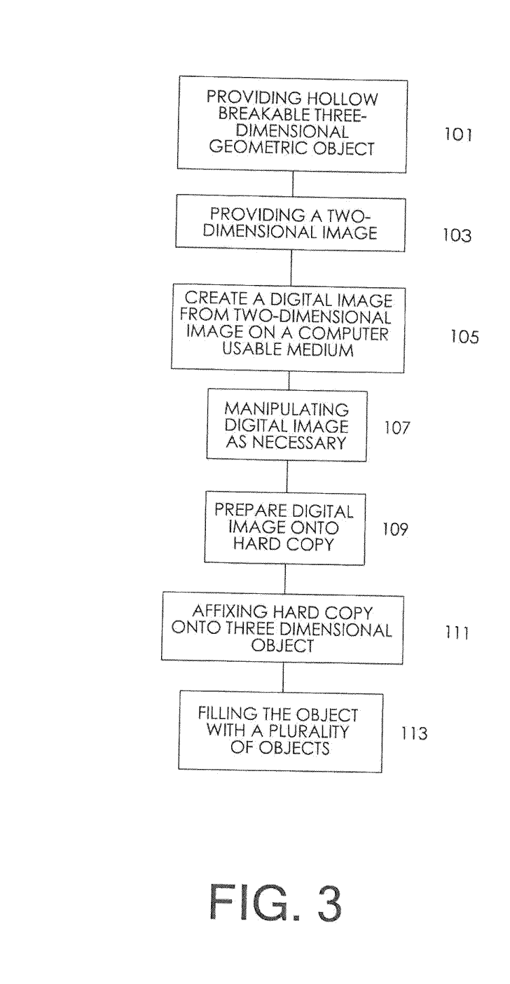

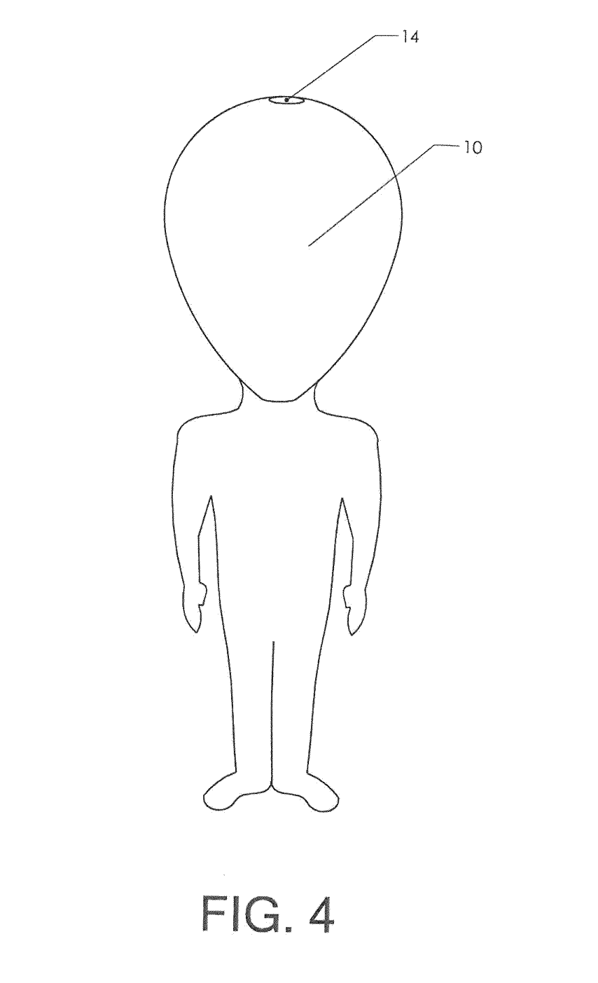

The present invention is a method of making a personalized piñata. The preferred embodiment of the present method is shown in FIG. 3. Step 101 includes providing a hollow breakable three-dimensional geometric object 10 (as shown in FIG. 4). FIG. 4 shows geometric object 10. The three-dimensional geometric object 10 is hollow and contains an opening 14 preferably at the top of the object. Opening 14 allows the user to fill the object 10 with items such as candy (as described herein). The reader will appreciate that geometric object 10 can be any shape or size. Additionally, geometric object 10 can be made by any known method of creating a hollow, three-dimensional geometric object 10 which can be broken. In the preferred embodiment geometric object 10 would be made by the prior art method as illustrated in FIG. 1, namely comprised of: (1) Providing a support structure 14, such as a balloon; (2) Providing and coating strips 16 of newspaper or paper in a paste 18; (3) Layering strips 16 on the support structure 14; (4) Drying strips 16 completely until a hardened geometric object 10 is formed (shown in FIG. 4); and (5) Removing support structure 14, for example popping the balloon.

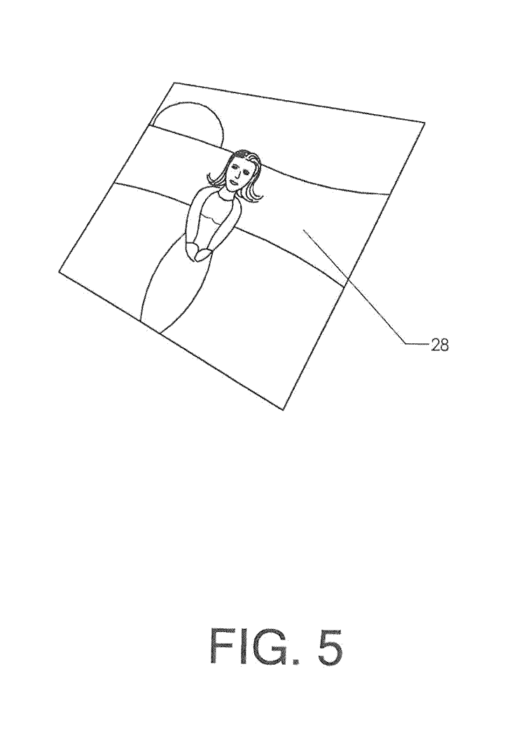

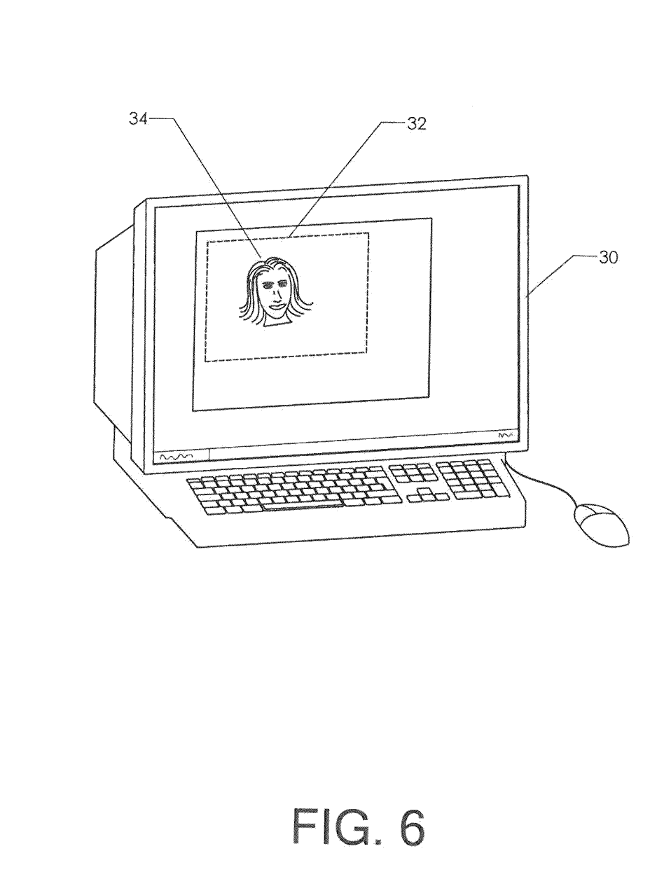

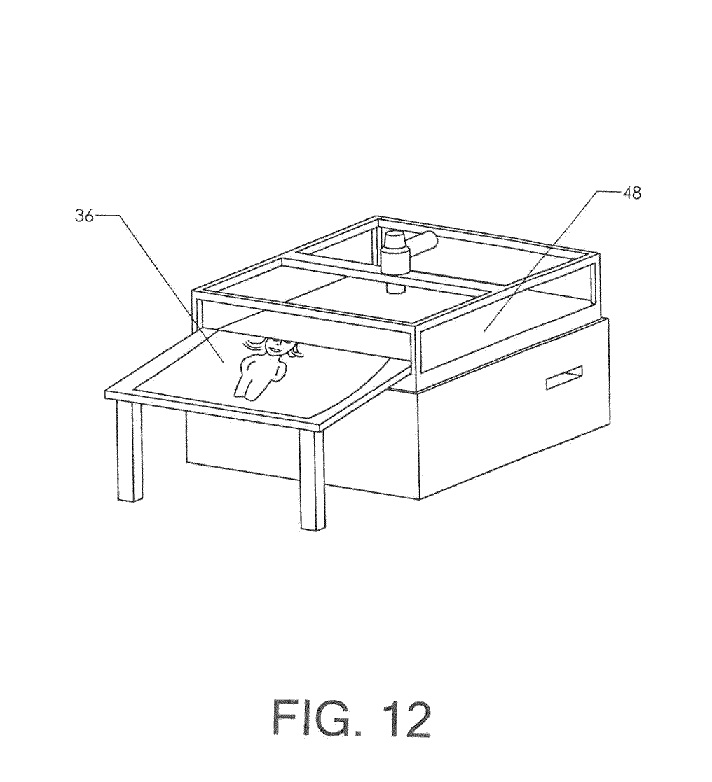

Returning to FIG. 3, step 103 includes providing a two-dimensional image 28 (as illustrated in FIG. 5). A consumer can select any image that he or she desires. In FIG. 5, two-dimensional image 28 is a standard printed photograph, however two-dimensional image 28 could be any type of two-dimensional image including a hand sketched drawing or painting. FIG. 3 illustrates step 105 wherein two-dimensional image 28 is transferred to a computer usable medium. Computer usable medium can be any RAM storage device that is capable of accepting or storing a digital image 34. FIG. 6 illustrates digital image 34 on a computer 30, however any electronic device or computer usable medium could be utilized. For example, FIG. 12 illustrates a silk-screen printer 48 which operates to receive a digital image and transform that digital image into a hard copy 36.

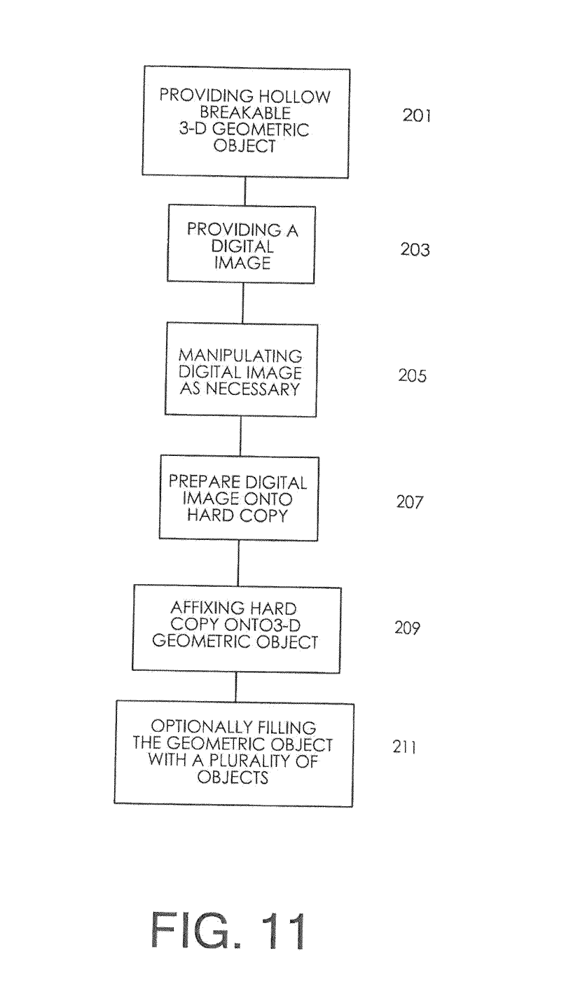

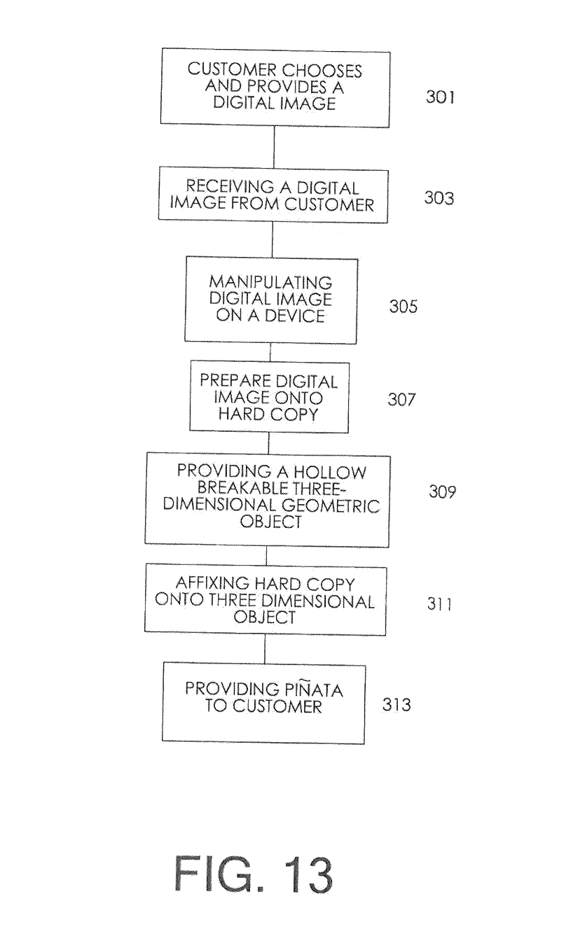

Two-dimensional image 28, shown in FIG. 5, can be uploaded to computer 30 shown in FIG. 6, by any known method, including a digital scanning device. Again, any computer usable medium could be utilized to store a digital image 34 of two-dimensional image 28. Once image is uploaded, computer or computer usable medium are preferably capable of displaying digital image 34. As illustrated in FIG. 6, crop box 32 can assist in choosing what portion of the digital image 34 will be used in the present method. While step 103 and step 105 are shown and described, they are only optional steps, as two-dimensional image 28 could already exist as a digital image 34 as shown in FIGS. 11 and 13 illustrating alternate embodiments of the present method.

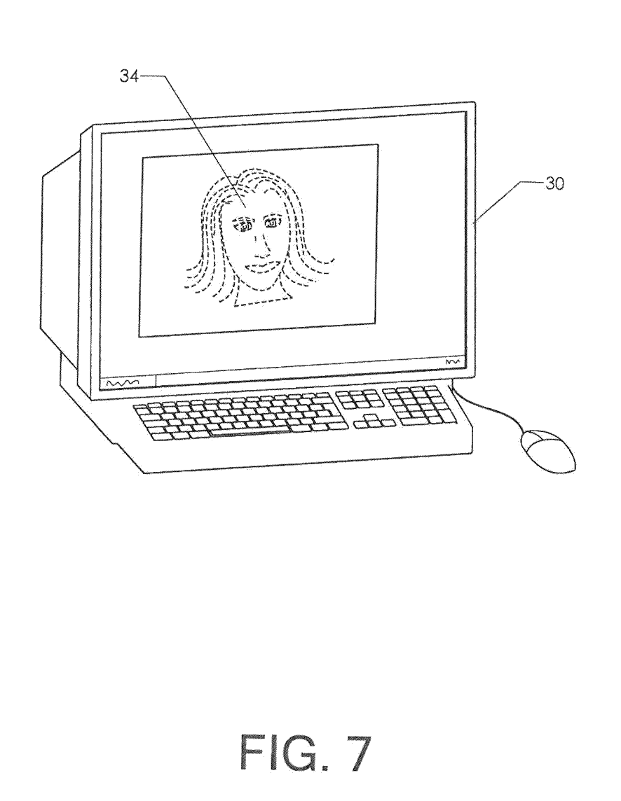

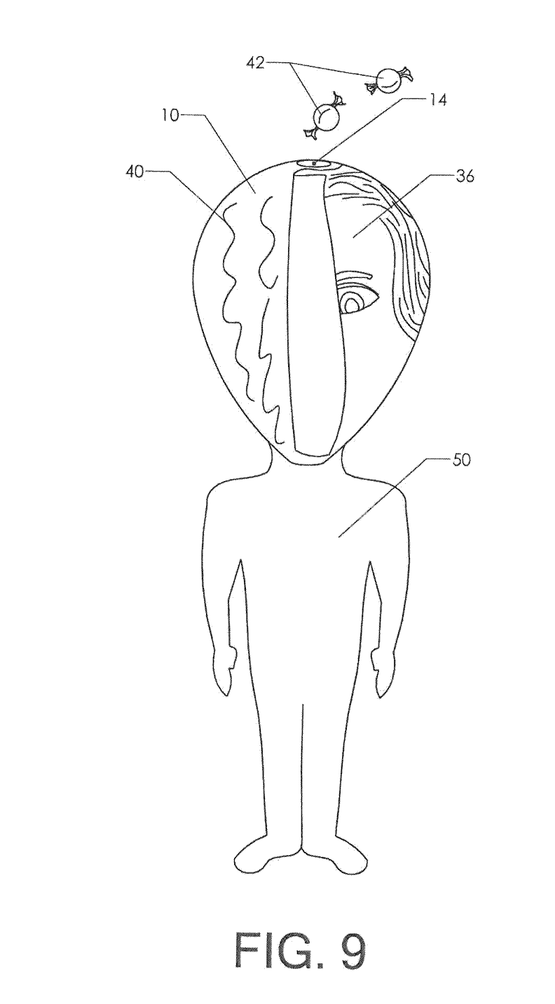

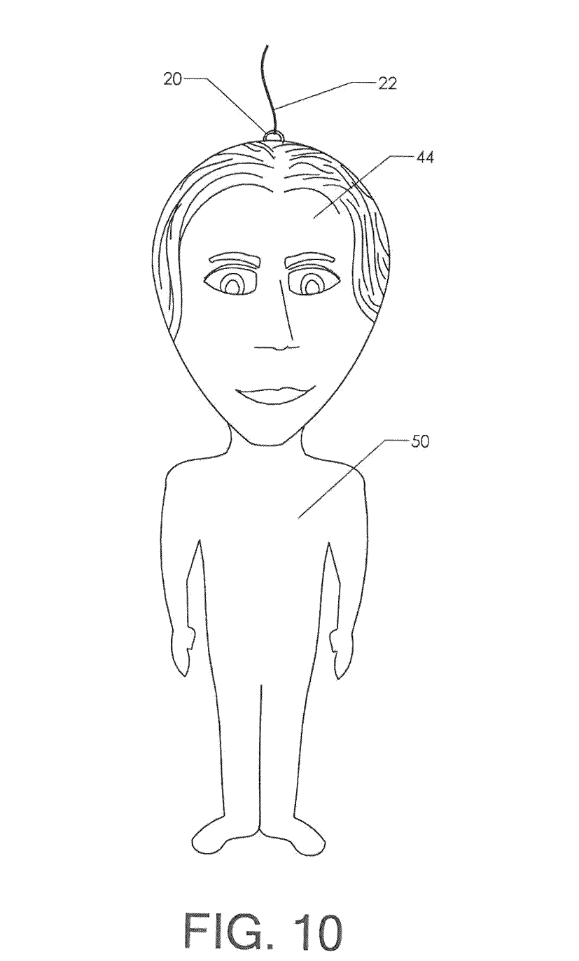

Step 107, in FIG. 3, includes manipulating the dimensions of digital image 34 (shown in FIG. 7) as necessary to create an image that can be applied to geometric object 10 (application of image further described in connection with FIGS. 9 and 10). In order for the digital image 34 to accurately represent a three-dimensional representation of a realistic two-dimensional image 28, dimensions of digital image 34 must be stretched and modified in order to wrap around the geometric object 10, as illustrated in FIG. 7. Dimensions of digital image 34 can be stretched and modified by any known program. The degree to which digital image 34 must be modified will vary significantly from one image to the next. In the preferred embodiment, a customer would choose either a two-dimensional image or digital image and send or electronically mail the image to a business entity which would manipulate the digital image, create the hard copy and prepare the piñata according to the customer's representations using the steps provided herein.

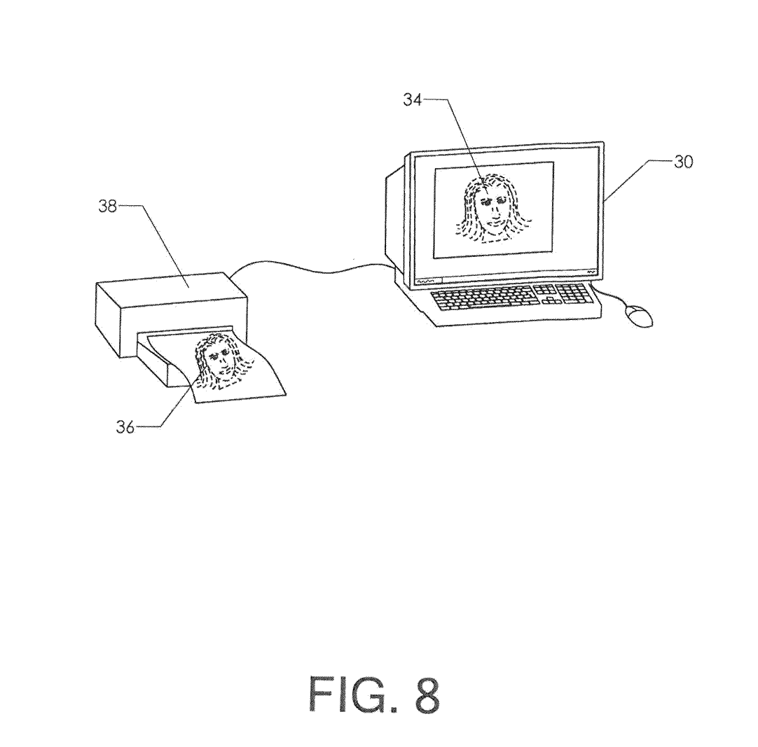

Step 109 includes preparing digital image 34 into a hard copy. As illustrated in FIG. 8, hard copy 36 is preferably produced utilizing a high quality printer 38. However, any known method of producing a hard copy 36 of digital image 34 can be used. For example, a silk screening process can be used to reduce two-dimensional image or digital image to a hard copy 36 (See FIG. 12). Further, hard copy 36 can be produced onto any material, including, but not limited to paper, photographic paper, polyurethane-polyurea copolymer, fabric, plastic, and/or aluminum.

Step 111 includes affixing hard copy 36 onto the three-dimensional geometric object 10, further illustrated in FIG. 9. In the preferred embodiment an adhesive 40 is used such as glue or shellac and hard copy 36 is affixed to geometric object 10. However, any adhesive or method of affixing material to geometric object 10 could be used. For example, material could simply wrap, be stretched over, or frictionally engage with geometric object 10. In the present embodiment, hard copy 36 would not completely surround to geometric object 10. Specifically, hard copy 36 surrounds the top of geometric object 10 while body 50 is decorated independently using known techniques.

As further shown in FIG. 9 and step 113 in FIG. 3, a plurality of objects 42, such as candy or small toys are used to fill geometric object 10 through opening 14. Once filled, opening 14 can be sealed. While step 113 is desirable it is not required in the present method of making a piñata, as the piñata could be left empty if desirable to the customer.

A completed piñata 44 is shown in FIG. 10, including a hook 20 and hanging line 22 which can be optionally attached to piñata 44. The personalized and/or lifelike nature of the present piñata 44 creates a product which can be used in most any event, including parties, fundraisers, business events and other social gatherings. Additionally, the present piñata 44 could be used as a collector's item or memorabilia item.

An alternate embodiment of the present method of making a piñata is shown in a schematic view in FIG. 11. Alternate embodiment is very similar to the preferred embodiment illustrated in FIG. 3; however, in the alternate embodiment the two-dimensional image is already in the form of a digital image, thus eliminating the need to upload a hard copy two-dimensional image to a computer usable medium. This may occur where the consumer may select a photograph taken on a digital camera or a mobile device. In that case, the consumer could directly transmit the digital image to the business, where the digital image will be transformed into a piñata. In the alternate embodiment, FIG. 11, step 201 includes providing a hollow breakable three-dimensional object; step 203 includes providing a digital image on a computer usable medium or other electronic device; step 205 includes manipulating the digital image by modifying the image to accommodate use on a three-dimensional surface; step 207 includes preparing the digital image onto a hard copy; step 209 includes affixing hard copy onto geometric object; and step 211 includes optionally filling the geometric object with a plurality of objects, including candy, small toys or confetti.

In another alternate embodiment illustrated in FIG. 13, step 301 includes the consumer choosing and providing a digital image 34. The consumer would transmit digital image 34 to the business entity creating the piñatas and step 303 includes receiving digital image 34 from consumer. Digital image 34 could be e-mailed or uploaded on-line to a database housed on a file server. Upon receiving digital image 34, the business entity would prepare the image, namely, step 305 including manipulating digital image 34 on an electronic device. Manipulation of digital image 34 could simply consist of cropping image or, in the alternative, dimensions of digital image 34 could be stretched to accurately represent a three-dimensional image. Step 307 includes preparing digital image 34 onto a hard copy 36. The reader will appreciate that creation of hard copy 36 may be realized by any device including silk-screening printers 48 (as illustrated in FIG. 12), digital printers or fabric printers. Step 309 includes providing a hollow breakable three-dimensional object 24. As stated above, three dimensional object 24 could be any shape or size. Step 311 includes affixing hard copy 36 onto geometric object and step 313 includes providing piñata 44 to the consumer.

The preceding description contains significant detail regarding the novel aspects of the present invention. It should not be construed, however, as limiting the scope of the invention but rather as providing illustrations of the preferred embodiments of the invention. As an example, any method of adhesive could be used to affix the hard copy of the image to the present three-dimensional geometric object. Thus, the scope of the invention should be fixed by the following claims, rather than by the examples given.

Having described my invention, I claim:

1. A method of making a piñata having a realistic image on said piñata, the steps comprising:
a. providing a three-dimensional geometric object with a hollow center;
b. providing a two-dimensional image;
c. uploading said two-dimensional image onto a device on a computer usable medium;
d. creating a digital image on said computer usable medium from said two-dimensional image wherein said digital image has a plurality of dimensions;
e. manipulating said plurality of dimensions of said digital image;
f. producing a hard copy of said digital image onto a material; and
g. affixing said material to said three-dimensional geometric object.

2. The method of claim 1, further comprising an opening on said three-dimensional geometric object.

3. The method of claim 2, further comprising the step of filling said geometric object with a plurality of objects through said opening.

4. The method of claim 1, wherein said realistic image is a human face.

5. The method of claim 4, wherein said plurality of dimensions are stretched such that said human face appears realistic around said three-dimensional object.

6. The method of claim 3, wherein said plurality of objects are a plurality of pieces of candy.

7. The method of claim 3, wherein said plurality of objects are a plurality of toys.

8. The method of claim 1, wherein said material is fabric.

9. The method of claim 1, wherein said material is a malleable plastic.

10. The method of claim 3, further comprising the steps of sealing said opening, attaching a hook said three-dimensional geometric object and hanging said three-dimensional geometric object by a hanging line.

11. A method of making a piñata having a realistic image on said piñata, the steps comprising:
a. providing a three-dimensional geometric object with a hollow center and an opening;
b. providing a digital image to a device, wherein said digital image has a plurality of dimensions;
c. manipulating said plurality of dimensions of said digital image;
d. producing said digital image onto a material; and
e. affixing said digital image to said three-dimensional geometric object.

12. The method of claim 11, further comprising the step of filling said geometric object with a plurality of objects through said opening.

13. The method of claim 11, wherein said realistic image is a human face.

14. The method of claim 13, wherein said plurality of dimensions are stretched such that said human face appears realistic around said three-dimensional object.

15. A method of making a piñata by a business entity for a consumer, wherein said piñata has a realistic image, the steps comprising:
a. receiving a digital image from said consumer, wherein said digital image has a plurality of dimension;
i. wherein said customer transmits said digital image to said business entity;
b. providing a three-dimensional geometric object with a hollow center and an opening;
d. producing said digital image into a hard copy onto a material;
e. affixing said hard copy to said three-dimensional geometric object; and
f. providing said customer with said piñata.

16. The method of claim 15, further comprising the step of filling said geometric object with a plurality of objects through said opening.

17. The method of claim 15, wherein said realistic image is a human face.

18. The method of claim 17, wherein said plurality of dimensions are stretched such that said human face appears realistic around said three-dimensional object.

19. The method of claim 15, wherein said hard copy is affixed to said three-dimensional geometric object by a cement glue.

20. The method of claim 15, wherein said customer transmits said digital image to said business entity by uploading said digital image onto a file server wherein said business entity can access said digital image.
